(19) United States
(12) Patent Application Publication
(10) Pub. No.: US 2022/0097408 A1
(43) Pub. Date: Mar. 31, 2022

(54) IMAGE QUALITY CONTROL FOR MULTI-PASS PRINTING

(71) Applicant: Hewlett-Packard Development Company, L.P., Spring, TX (US)

(72) Inventors: Gianni Cessel, Sant Cugat del Valles (ES); Raimon Castells De Monet, Sant Cugat del Valles (ES); Pablo Eduardo Carrasco Zanini Gonzalez, Sant Cugat del Valles (ES); Dorkaitz Alain Vazquez Fernandez, Sant Cugat del Valles (ES)

(73) Assignee: Hewlett-Packard Development Company, L.P., Spring, TX (US)

(21) Appl. No.: 17/417,335

(22) PCT Filed: Apr. 29, 2019
(86) PCT No.: PCT/US2019/029654

§ 371 Date: Jun. 22, 2021

(51) Int. Cl. B41J 2/21

(52) U.S. Cl. CPC B41J 2/2139; B41J 2/2142

(57) ABSTRACT

A printing carriage comprises a printhead, and two sensors for scanning an image deposited on a print media by the printhead. The sensors are provided on opposite sides of the printhead in a direction of movement of the printhead so that, during a printing pass of the printhead on the print media, one sensor is positioned on a trailing side of the moving printhead.

### BACKGROUND

In multi-pass printing systems, a printing carriage including a printhead is moved across a print media wherein, during each subsequent print pass, a portion of the printed image is deposited on the print media. In order to ensure a consistent image quality during multi-pass printing, printed images may be scanned for artefacts in order to be able to remove defects for subsequent images.

### BRIEF DESCRIPTION OF DRAWINGS

Examples will now be described, by way of non-limiting example, with reference to the accompanying drawings, in which:

FIG. 1 is a simplified schematic of an example of a printing carriage provided with sensors;

FIG. 2 is a simplified schematic of an inkjet printer comprising an image quality assessment unit; and

FIG. 3 is a flowchart of an example of a method for performing image quality control of images printed using an inkjet printer.

### DETAILED DESCRIPTION

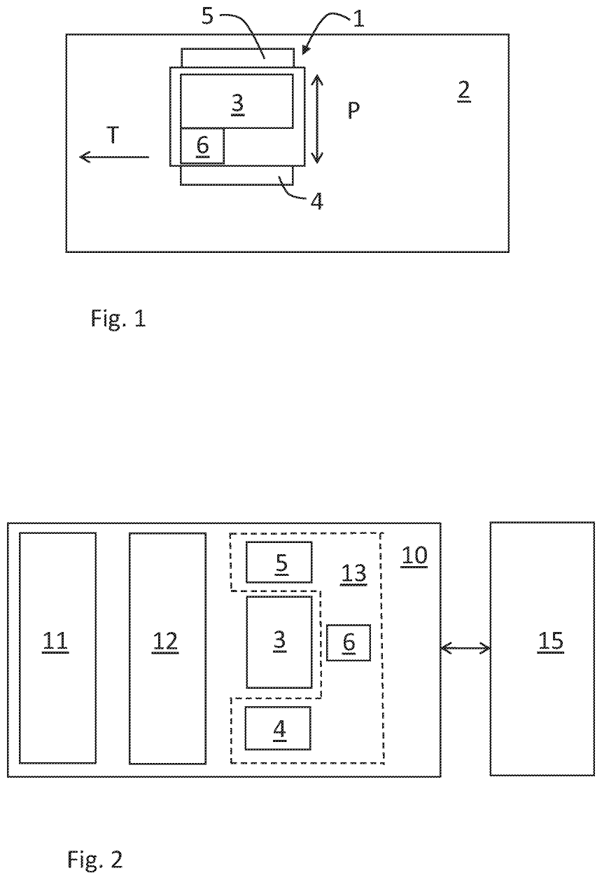

FIG. 1 shows a schematic view of a printing carriage 1 which may be employed in a printer, e.g., an inkjet printer or a 3D printer wherein a printhead 3 deposits droplets of a printing fluid onto a print media 2. The printing carriage may also be employed in a non-inkjet printer, such as a toner-based printer or other printer types. During multi-pass printing, the printing carriage 1 is moved backwards and forwards across the print media 2 in a printing pass direction P while the print media 2 is transported past the printing carriage 1 in a transport direction T. The alignment of the printing carriage 1 with the print media 2 may thus impact the quality of the printed image, especially if the print media 2 is supplied as a roll of continuous material and the printing carriage 1 is driven to print a large amount of image data on the continuous material for printing processes lasting a long time, such as all night.

The printing carriage 1 is further provided with two sensors 4, 5 provided at opposite ends of the printing carriage 1 in the printing pass direction P. Thus, during any printing pass in the printing pass direction P, one of the sensors 4, 5 is positioned at a leading edge of the printing carriage 1, while the other of the sensors 4, 5 is provided at a trailing edge of the printing carriage 1. The sensor 4, 5 at the trailing edge of the printing carriage 1 in the printing pass direction P may acquire and digitize an image of the pattern of printing fluid that has been deposited by the printhead 3 during the printing pass.

Further, according to some examples, the sensor 4, 5 at the leading edge of the printing carriage 1 may scan and digitize an image prior to deposition of a print pattern in the current printing pass, which may be used as a reference image of the portion of the printed image that is already available on the print media 2 or as a reference image of the print media 2 prior to printing. Based on the acquired image by the leading sensor 4, 5 a condition of the print media 2, such as alignment, surface properties or the like may be determined prior to deposition of a printed image or of a portion of a printed image on the print media 2 during the current printing pass.

According to examples, each sensor 4, 5 may be sufficiently sized so that it can record at least the whole pattern that is deposited by the printhead 3 during a single printing pass. According to an example, the sensor may have a scanning width of 8.5 inches. The scanning width of the sensor may also take a different value according to the dimensions of the printhead 3. The processing speed of each sensor may be set such that it is at least as large as the printing speed of the printhead, such as for example a processing speed of 60 inch/sec for image scanning and digitization, which allows a real-time capturing of the deposited pattern of printing fluid during each printing pass, using the respective sensor 4, 5 which trails the printhead 3. According to some examples, more than two sensors may be provided.

Further, the printer carriage 1 may be provided with a controller 6 for acquiring a scanned and digitized image from the sensor 4, 5 on the trailing side of the moving printhead 3. The controller 6 may further acquire a scanned and digitized image from the sensor 4, 5 on the leading side of the moving printhead 3. The controller 6 may perform an image quality analysis by comparing the acquired scanned and digitized image with print data. The result of the comparison may be used for adjusting the position and the properties of the printhead 3, such as colour saturation, droplet size of the printing fluid, or the like, or for determining printer actions such as cancelling the print job and reprint after re-conditioning for image quality.

Since the image is scanned in a location close to where the printhead 3 deposits the printing fluid on the print media 2, the alignment of the printing carriage 1 relative to the print media 2 and relative to previous portions of the printed image can be determined with high precision just as the respective portion of the printed image is generated. Thus, any faults in the printed image can be detected substantially in real time.

Further, a high degree of correlation between the print data and the deposited printing fluid pattern can be achieved, since the controller 6 of the printing carriage 1 or a controller within the printing system can compare the acquired scanned image with the print data that has been used for forming the scanned portion of the print image. Thus, when e.g. image faults like streaks due to a highly viscous printing fluid or the like occur in the printed image, the controller 6 may adjust parameters of the printhead 3, such as the droplet size, or may initiate measures such as nozzle replacement or adjustment of printing algorithms in order to improve image quality during an ongoing printing process.

According to examples, the controller 6 may also perform a printhead calibration procedure wherein the deposited pattern of printing fluid is compared to calibration print data, and a diagnosis of printhead performance as well as a calibration of printhead parameters such as printhead alignment and other calibrations may be performed.

The controller 6 may further provide the digitized scanned image and the corresponding print data to an external device for further image quality (IQ) analysis. Therein, the digitized scanned image and the corresponding print data may be analysed by IQ processing and an automatic decision regarding the image quality may be taken by the system. According to examples, the automatic decision may comprise stopping the printer when image quality is deemed to be too low or the automatic decision may comprise taking other actions, such as re-calibration of the printhead 3 or of specific sections of the printhead 3, or of disabling a section of the printhead 3 if it has been detected to be faulty, and instead using other sections of the printhead 3 for continuing the print job.

While the sensors 4, 5 may be dimensioned such that they are at least the same width as the printhead 3 in a direction perpendicular to the printing pass direction P, the sensors 4, 5 may be fairly compact in a direction parallel to the printing pass direction P. Thus, the overall size of the printing carriage 1 is not substantially increased by the provision of the sensors 4, 5 at opposite edges of the printing carriage 1 in the printing pass direction.

According to examples, the printhead 3 may comprise multiple sections which can be controlled independently from each other. During a multi-pass printing operation, specific printhead sections may be used for depositing printing fluid on the print media 2 for each printing pass. Hence, the respective trailing sensor 4, 5 may be able to record an image printed by a specific section of the printhead 3 during a given printing pass. This enables the controller 6 to assess image quality for specific printhead sections in order to eliminate faults from the printed image by re-adjusting or re-calibrating those sections of the printhead 3 which have been identified as potentially faulty. Therein, according to an example, a printhead section may comprise a group of printing nozzles, and faults in specific nozzles of a printhead section may be detected by analysing a printed pattern deposited in a printing pass by the printhead section.

During a multi-pass printing operation, wherein the printing carriage 1 passes multiple times of a specific area of the print media 2, while different sections of the printhead 3 deposit a pattern of printing fluid droplets in each printing pass, the respective trailing sensor 4, 5 may be used to detect the image printed so far onto the print media 2 at each printing pass. Thus, any defects in the printed image may be recorded and analysed multiple times. According to some examples, the sensors 4, 5 may be selectively switched on or off for some printing passes or for specific portions of a printing pass, so that the amount of digitized image data which is analysed for image quality control can be reduced.

FIG. 2 shows a printer 10 comprising a printhead 3 as described above in conjunction with the printing carriage 1, a media transport mechanism 11 for transporting the print media 2 in the transport direction T (see FIG. 1), a printhead drive mechanism 12 for moving the printhead 3 backwards and forwards relative to the print media 2, in the printing pass direction P and an image quality assessment unit 13, comprising the controller 6 and the two sensors 4, 5 provided at opposite sides of the printhead 3 in the printing pass direction P.

The media transport mechanism 11 may transport a continuous print media 2 past the printhead 3, wherein the media transport mechanism 11 may comprise a media advance sensor in order to determine and adjust alignment between the print media 2 and the printhead 3. According to examples, the print media 2 may also be provided as individual sheets or boards.

According to examples, the sensors 4, 5 provided at opposite ends of the printhead 3 may be used for the inspection of correct advance of the print media 2 as well as the IQ of the image just deposited.

Therein, the controller 6 may receive a scanned image from the sensor 4, 5 trailing the printhead 3 in the printing pass direction P and perform an image quality analysis based on the received image and on print data. The controller 6 may further control the printing operation of the printhead 3 according to the print data.

According to some examples, at least a preliminary IQ analysis may be performed in the controller 6 or using any further processors provided in the image quality assessment unit 13 of the inkjet printer 10. According to exampled, IQ analysis may also be performed in an external device 15 which is connected to the inkjet printer 10 via a wired or wireless communication link.

The image quality assessment unit 13 may identify a fault in the printhead 3 or in a specific printhead section based on the result of the IQ analysis of a scanned image acquired during a printing pass of the printhead 3. As described above in conjunction with the printing carriage 1, the image quality assessment unit 13 may perform an automated analysis and take automatic measures, such as turning off the printer, displaying a warning message, re-aligning the print media 2 using the media transport mechanism 11, re-calibrating the media advance sensor of the media transport mechanism 11, or re-calibrating or realigning the printhead 3 or specific sections thereof, when image quality of the printed image is determined to be insufficient.

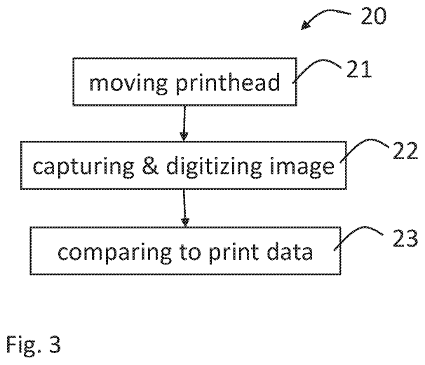

FIG. 3 shows a method 20 for performing image quality control of printed images. The method may be used for images printed using an inkjet printer, such as an inkjet printer using a multi-pass printing process, or may be used for images using a non-inkjet type printer. Block 21 comprises moving a printhead 3 backward and forward in a printing pass direction P relative to a print media and depositing a print pattern on the print media 2. In the case of an inkjet printer, the print pattern may comprise a pattern of printing fluid droplets. Therein, multi-pass printing may be employed, wherein the printhead 3 is passed multiple times over the same area of the print media 2 while a portion of the printed image is deposited on the print media 2 during each printing pass.

During the printing pass, the method may further comprise capturing and digitizing an image of the deposited print pattern on the print media 2 using a scanner 4, 5 provided on the trailing side of the printhead 3 in the printing pass direction P (block 22). Thus, the image of the deposited print pattern may be acquired just as it is created on the print media 2, providing substantially real-time digitized data of the printed image as it is produced.

The digitized captured image of the deposited print pattern may then be compared to print data (block 23) in order to enable an IQ analysis of the printed image or partial image as it is created. Thus, any defects in the printed image can be detected substantially in real-time during the printing process, and suitable measures, such as turning off the printer or calibrating the printhead 3, can be performed automatically based on the result of the IQ analysis.

In summary, the examples described above thus provide a printing carriage 1, an inkjet printer 10 and a method 20 for performing IQ analysis of printed images in a fast and efficient manner. The sensors 4, 5 provided at opposite edges of the printhead 3 in the printing pass direction P are compact devices which do not need their own driving mechanism and which may be as wide as the printhead 3 in order to be able to scan the whole surface of the print media 2. Thus, even for print jobs that are run overnight, using print media 2 that is continuously supplied on a roll, an automated IQ analysis can be performed while the print job is executed, and suitable measures can be taken immediately when a defect is detected in the printed image. For multi-pass printing, defects in the printed image can be detected during each printing pass, even when a partial image has been printed yet. In order to reduce the processing load of the IQ analysis, the sensors 4, 5 may be selectively switched on and off during a printing pass in order to capture images during selected printing passes or during selected portions of a printing pass.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. Printing carriage, comprising:
a printhead, and
two sensors for scanning an image deposited on a print media by the printhead,
wherein the sensors are provided on opposite sides of the printhead in a direction of movement of the printhead so that, during a printing pass of the printhead on the print media, one sensor is positioned on a trailing side of the moving printhead.

2. Printing carriage according to claim 1, further comprising a controller for receiving print data, controlling the printhead to print an image based on the print data, acquiring a scanned image from the sensor on the trailing side of the moving printhead, and comparing the scanned image to the received print data.

3. Printing carriage according to claim 2, wherein the controller is further for acquiring a scanned image from the sensor on the leading edge of the moving printhead and determining a condition of the print media prior to depositing the image on the print media by the printhead.

4. Printing carriage according to claim 2, wherein the controller is further for switching the sensor on the trailing side of the moving printhead on or off during the printing process for acquiring the whole, a part or no image of a given printing pass.

5. Printing carriage according to claim 1, wherein each sensor is for acquiring and digitizing the pattern deposited by the print head on the print media during a printing pass.

6. Printing carriage according to claim 5, wherein the processing speed of each sensor for acquiring and digitizing the deposited image is at least as high as the printing speed of the printhead.

7. Inkjet printer, comprising:
a printhead,
a media transport mechanism for transporting print media in a transport direction,
a printhead drive mechanism for moving the printhead backwards and forwards relative to the print media, in a printing pass direction which is perpendicular to the transport direction of the print media,
an image quality assessment unit, comprising a controller and two sensors provided at opposite sides of the printhead in the printing pass direction,
wherein the controller is to receive a scanned image from the sensor trailing the printhead in the printing pass direction and to provide data for an image quality analysis based on the received image and on print data.

8. Inkjet printer according to claim 7, wherein the printhead comprises multiple sections, and wherein, in a single printing pass, a section of the printhead is used for printing a portion of the image to be printed onto the print media.

9. Inkjet printer according to claim 8, wherein the image quality assessment unit is further for identifying a fault in a specific printhead section based on the image quality analysis of a scanned image acquired during a printing pass.

10. Inkjet printer according to claim 7, wherein the media transport mechanism is for transporting a continuous print media in the transport direction.

11. Method for performing image quality control of printed images, comprising:
moving a printhead backward and forward in a printing pass direction relative to a print media and depositing a print pattern on the print media;
capturing and digitizing an image of the print pattern on the print media using a scanner provided on the trailing side of the printhead in the printing pass direction;
comparing the digitized captured image to print data.

12. Method according to claim 11, further comprising:
calibrating the printhead based on a result of the comparison of the digitized captured image with the print data.

13. Method according to claim 11, further comprising:
capturing and digitizing an image of the print media prior to depositing the print pattern using a scanner provided on the leading side of the printhead; and
determining a condition of the print media prior to depositing the print pattern on the print media.

14. Method according to claim 11, further comprising:
stopping a printing process based on a result of the comparison of the digitized captured image with the print data.

15. Method according to claim 11, further comprising:
switching the scanner provided on the trailing side of the printhead in the printing pass direction in order to select which part of the printed image deposited during the printing pass is to be recorded by the scanner.
